(19) United States
(12) Patent Application Publication
(10) Pub. No.: US 2010/0131547 A1
(43) Pub. Date: May 27, 2010

(54) DIGITAL ASSET MANAGEMENT SYSTEM, INCLUDING CUSTOMIZABLE METADATA MODEL FOR ASSET CATALOGING AND PERMISSIONING OF DIGITAL ASSETS, SUCH AS FOR USE WITH DIGITAL IMAGES AND SONGS

(75) Inventors: Alan Magrath, Croydon (GB); Lawrence Crowther, London (GB); Chris Borrett, London (GB); Lawrence Mount, London (GB); Dave Piggin, Brighton (GB)

Correspondence Address: PERKINS COIE LLP;PATENT-SEA, P.O. BOX 1247, SEATTLE, WA, 98111-1247, US

(73) Assignee: Getty Images, Inc., Seattle, WA (US)

(21) Appl. No.: 12/467,218

(22) Filed: May 15, 2009

Related U.S. Application Data
(63) Continuation of application No. 11/399,692, filed on Apr. 6, 2006, now abandoned.
(60) Provisional application No. 60/669,206, filed on Apr. 6, 2005.

(51) Int. Cl. G06F 17/30

(52) U.S. Cl. 707/769; 707/802; 707/784; 707/E17.044; 707/E17.014; 707/E17.005

(57) ABSTRACT

A method, system, and metadata model is provided that allows for the organization of electronic assets, such as songs, videos, documents, images, etc. Virtual libraries are created based on virtual copies of assets created based on metadata, thereby avoiding copying of the actual assets. The metadata model also facilitates searching for assets from the virtual libraries and the implementation of permissioning schemes.

### CROSS-REFERENCE TO RELATED APPLICATION

This application is a continuation of U.S. patent application Ser. No. 11/399,692, filed Apr. 6, 2006 entitled “DIGITAL ASSET MANAGEMENT SYSTEM, INCLUDING CUSTOMIZABLE METADATA MODEL FOR ASSET CATALOGING AND PERMISSIONING OF DIGITAL ASSETS, SUCH AS FOR USE WITH DIGITAL IMAGES AND SONGS”, which claims priority to U.S. Provisional Patent Application No. 60/669,206, filed Apr. 6, 2005 entitled “Digital Asset Management System, Including Data Structure for Providing Differing Permissions Associated with the Assets, such as for use with Digital Images and Songs.”

### BACKGROUND

The practice of exchanging data via computers that have been networked has been occurring for decades. One use for computers and computer networks includes providing a centralized collection of reusable media components, or digital assets, which can then be distributed to multiple users. Using a centralized collection of digital assets (as opposed to multiple local collections) can both lower the cost and speed the execution of tasks that utilize such digital assets (e.g., global brand-marketing strategies). However, simple centralization often fails to produce meaningful time and cost advantages for large organizations. For example, regardless of whether a company keeps regimented control of its assets or, alternatively, freely releases them for local usage, typical distribution paths often mean that groups and divisions will pass materials from group to group several times before they reach their final audience. Further difficulties with current techniques arise from the use of rapidly evolving rich-media technologies that demand information technology (IT) capability that is beyond the expertise of most enterprise IT organizations.

### BRIEF DESCRIPTION OF THE DRAWINGS

FIG. 1 is a block diagram showing an example of an environment in which the asset management facility may be implemented in an embodiment.

FIG. 2 is a block diagram illustrating additional details regarding the asset management facility in an embodiment.

FIG. 3 is a block diagram showing sample contents of the asset repository of FIG. 1.

FIG. 4 is a block diagram showing a first example of a scheme for allocating libraries of digital assets.

FIG. 5 is a block diagram showing a second example of a scheme for allocating libraries of digital assets.

FIG. 6 is an entity relationship diagram showing relationships between entities of the asset management facility in an embodiment.

FIG. 7 is a flow diagram showing an example of a routine for generating asset metadata in an embodiment.

FIG. 8 is a flow diagram showing an example of a routine for searching based on asset metadata in an embodiment.

FIGS. 9A, 9B, 10A, and 10B are display diagrams illustrating aspects of assets and associated asset metadata in an embodiment.

### DETAILED DESCRIPTION

Described in detail herein is an asset management facility for efficient and effective management, receiving, storing, organizing, and distributing of digital assets (e.g., documents, audio data, image data, video data, etc.). In some embodiments, aspects of the facility operate using a single centralized database that forms a multi-tenant virtualized environment. For example, the single database may contain digital assets, metadata associated with digital assets, and a structure for distributing digital assets among multiple virtual libraries. While the single database may be centralized, the multiple virtual libraries may be configured to represent business or geographic divisions within a company or set of companies. All users can access the system using intranets, or the Internet and browser/web-based tools. Each user is able to see his or her own permissioned view of the libraries and assets he or she has access to. The facility may also provide search and publishing/distribution facilities. The facility may provide numerous benefits, such as global distribution of digital data (e.g., simultaneous distribution of movie posters, trailers, songs, and so forth), flexible dynamic metadata schemes that can be customized across multiple organizations, effective and efficient search capabilities based on metadata, a granular permissions model based on metadata, etc.

In some embodiments, the asset management facility supports establishing virtual libraries as a framework for distributing digital assets. The virtual libraries may provide access to the assets at a “local” level, thus allowing for fine-grained local permissions models, reducing asset retrieval transaction times, etc. In a first example, Acme Headquarters (the headquarters for digital assets within Acme Company) employs the asset management facility to define a primary library that contains effectively all of the official corporate digital assets associated with that organization or group. Each asset includes metadata that aids in the creation of other virtual libraries that function as “local” sub-libraries. In particular, each asset may be associated with one or more metadata definitions that are each unique to a particular owner and/or site (e.g., each Acme subsidiary may be considered an owner and have its own site through which the assets in its virtual library can be accessed).

Through the use of multiple virtual libraries (defined based on metadata definitions for each asset that are, possibly, unique to each subsidiary), Acme Headquarters provides Acme's subsidiaries/remote offices with access, ownership, or rights to use a subset of the assets within the Acme Headquarters' primary library, as if each subsidiary has its own locally contained library of assets. In some embodiments, the asset distribution theme described above can be repeated down a hierarchy of subsidiaries, where assets and metadata can flow up and down the hierarchy as appropriate.

The configurations described above provide benefits of both centralized systems and localized systems. For example, system administrators and Acme Headquarters can easily make changes to assets and/or asset metadata that can be set to immediately take effect in each of the virtual libraries. Examples of such changes include removing an asset from the system altogether (e.g., in the case that a license to use the asset has expired or that the asset is found inappropriate), providing foreign language translations for assets, changing descriptive information associated with an asset, etc. System administrators at the subsidiary level may be free to make certain changes that affect the assets that reside in the subsidiary's virtual library by making changes to the subsidiary-specific metadata for each of the assets. For example, a subsidiary system administrator may provide locally appropriate foreign language translations for the subsidiary's assets, change the composition of metadata associated with its assets at the local level (e.g., add new metadata fields that only make sense at the subsidiary level), etc. Likewise, the flexibility of asset metadata at the local level may facilitate setting up different categories of users that are also represented with flexible metadata with different types of access permissions, thereby providing a fine-grained permissions model, which can be implemented even at the atomic (individual) asset level (e.g., user Jane Doe can see asset XYZ and user John Smith can see asset ABC). In this way, permissions information is integrated into the asset metadata to comprise a single metadata document (as opposed to being contained in a separate permissions mechanism or structure). This allows the metadata to support complex permissions models and permits a large number of assets without slowing the system.

The flexibility of asset metadata described herein can be implemented without the need for “hard coding” or programmatic application changes. In other words, the client configuration, library structures, and metadata model can be dynamically created and changed and applied through the use of simple web-based forms. For example, these and similar tools may allow administrative users to configure the structure and composition of metadata and create individual virtual libraries or to otherwise control access to assets within a large organization. The metadata model may also allow for flexible definitions of metadata structures for users, assets, and projects. In some embodiments, this may be standard across all parts of a company. In some cases, the individual libraries may be tailored to suit local group needs. The metadata model may also facilitate searching for users, assets and projects. These search facilities can also be configured through web-browser based tools. Accordingly, the facility may implement permissions/access rules in conjunction with performing metadata based and/or free text searches.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

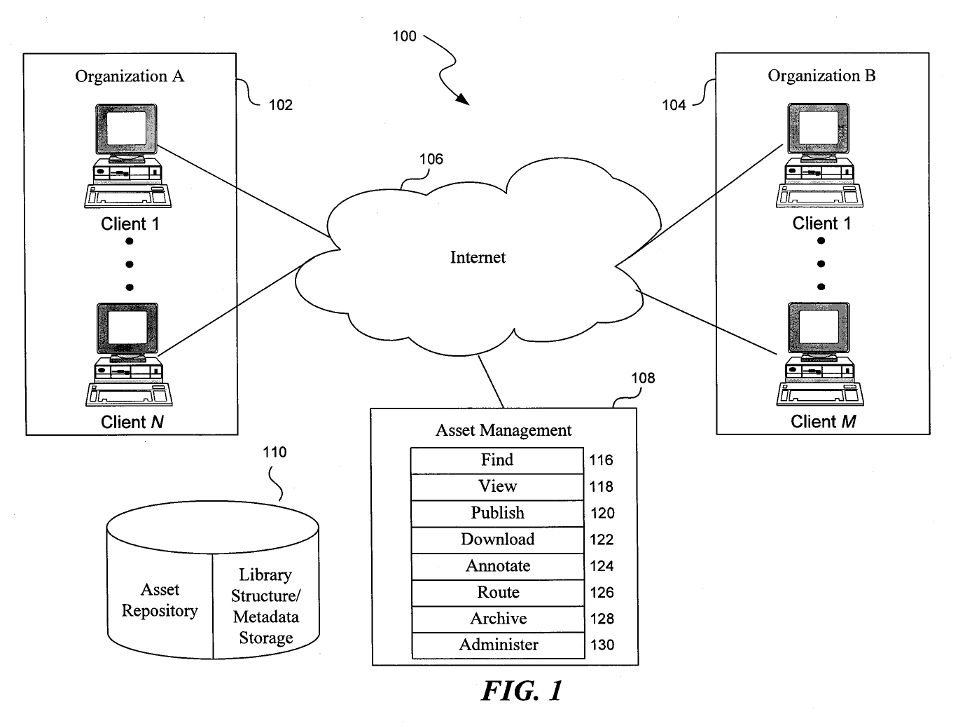

FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, and the like. The invention can be embodied in a special purpose computer or data processor that is specifically programmed, configured, or constructed to perform one or more of the computer-executable instructions explained in detail below. Indeed, the term “computer,” as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, a system or environment 100 in which the asset management facility may be implemented includes at least a first organization (e.g., Organization A) 102 and a second organization (e.g., Organization B) 104. Both organizations (102 and 104) are consumers of digital assets, and may also be, in some cases, generators/creators of digital assets. Each organization (102 and 104) may have several client devices associated with it, such as personal computers (e.g., PC or Mac) or workstations having one or more processors coupled to one or more data storage devices. The data storage devices may include any type of computer-readable media that can store data accessible by the client devices, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a network connection port or network node.

Each client device may also be coupled to at least one user input device and at least one output device such as a display device, as well as one or more optional additional output devices (e.g., printer, plotter, speakers, tactile or olfactory output devices, etc.), thereby allowing users to access digital assets that are made accessible to the client devices. For example, the input devices may include a keyboard and/or a pointing device such as a mouse. Other input devices are possible such as a microphone, joystick, pen, game pad, scanner, digital camera, video camera, and the like. In some embodiments, the client computers associated with the organizations (102 and 104) access digital assets via a network 106, which connects the organizations (102 and 104) to an asset management facility 108 of the system 100. While the Internet is shown to represent the network 106, a private network, such as an intranet, may indeed be preferred in some applications.

The asset management facility 108 may comprise at least one server computer coupled to the network 106 that performs much or all of the functions for receiving, routing, and storing of digital assets. Accordingly, the asset management facility 108 may be part of a server system within an organization or subgroup within an organization. However, other configurations may be possible. Various databases coupled to the asset management facility 108 may include an asset repository/metadata storage facility 110. The asset repository/metadata storage facility 110 may store the information comprising the digital assets themselves, as well as metadata and metadata definitions for each asset existing in a virtual library, thereby defining one or more library structures that allow the organizations (102 and 104) to obtain access to select groups of the digital assets. While shown and described above as being contained in a single database, the information in the asset repository/metadata storage facility 110 may also be distributed in multiple databases.

Aspects of the asset management facility 108 may employ security measures to inhibit malicious attacks on the system 100 and to preserve the integrity of the data stored therein (e.g., firewall systems, secure socket layers (SSL), password protection schemes, encryption, and the like).

The asset management facility 108 may provide various functionalities. Examples of such functionalities are depicted in FIG. 1 and include find asset functionality 116, view asset functionality 118, publish asset functionality 120 (e.g., used by asset creators to make assets available and set permissions for access to such assets), download asset functionality 122, annotate asset functionality 124 (e.g., annotations can be used for facilitating searching as well as describing the asset and providing information about its use), route asset functionality 126, archive asset functionality 128, administer asset functionality 130, etc.

The asset management facility 108 and its associated functionality may be implemented using several subcomponents (not shown) such as a server engine, a web page management component, a database management component, a distributed file system component, etc. For example, the server engine may perform basic processing and operating system level tasks. The web page management component may handle creation and display or routing of web pages. The database management component may facilitate storage and retrieval tasks with respect to the database, queries to the database, and storage of data. The distributed file system component may couple aspects of the asset management facility 108 to the asset repository 110 and may manage and transparently locate pieces of information (e.g., assets) from remote files or databases and distribute files across the network 106. The distributed file system component may also manage read and write functions to the databases. In addition, to facilitate quick searches, the distributed file system component may cache metadata/permissions documents for fast access.

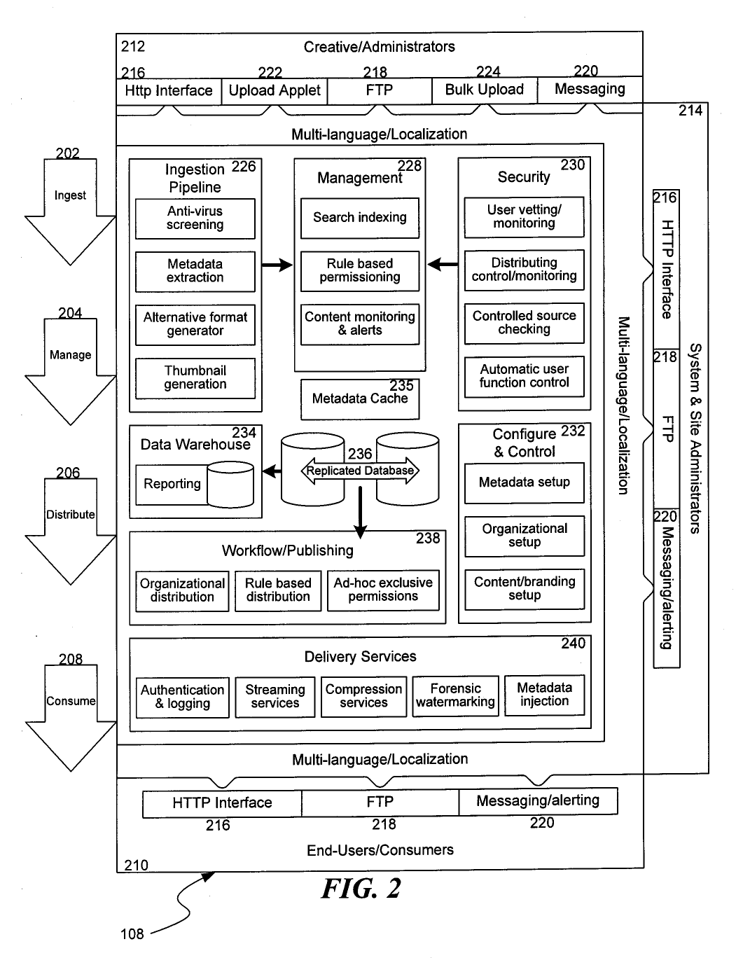

FIG. 2 is a block diagram illustrating a more detailed view of aspects of the asset management facility 108 of FIG. 1. In general, the asset management facility 108 may provide functionality associated with ingesting assets 202, managing assets 204, distributing assets 206, and consuming assets 208. Accordingly, high-level user groups associated with the system include end users/consumers 210, creative users/administrators 212, and system and site administrators 214. To access the asset management facility 108, the end users/consumers 210, the creative users/administrators 212, and the system and site administrators 214 may have access to http interface tools 216, FTP tools 218, and messaging/alerting tools 220. In addition, the creative users/administrators 212 may have access to uploading tools, including an upload applet tool 222 and a bulk upload tool 224, which allow such users to upload assets to the asset management facility after they have been created. These web-based configuration tools and possibly others allow for rapid setup and changes to system resources.

The functional components of the asset management facility 108 may include an ingestion pipeline 226 for the ingestion of assets into the system. For example, the ingestion pipeline 226 may screen incoming assets for viruses, allow for the automatic extraction of metadata from assets, allow for the generation of alternative formats for assets, allow for thumbnail generation, etc. The functional components of the asset management facility may also include a management component 228. For example, the management component 228 may allow for search indexing so assets can be easily searched by end users, facilitate system administrators to create a rule-based permissions model to restrict access to assets and/or create sub-libraries, allow for system administrators to perform content monitoring, etc.

A security component 230 of the asset management facility 108 may allow system administrators (and/or site administrators) to perform vetting/monitoring of user activities associated with the asset management facility 108, as well as distribute control and monitoring task. The security component 230 may also allow controlled asset source checking and automatic user function control. The security component 230 may cover hardware, application, and SLL-based user authentication to protect customer assets. A configuration and control component 232 may allow system administrators (and/or site administrators) to set up metadata for assets, set up organizational structures, set up content and branding, etc. In a multiple-site environment, aspects of the configuration and control component 232 may facilitate the system-wide propagation of upgrades to all customers without the need for site-by-site installations and work-arounds. A metadata caching layer 235 is linked to both a database 236 and aspects of the management component 228. In some embodiments, the metadata caching layer 235 is designed to optimize and centralize current recently used assets. As users perform normal search and browse activity, the metadata caching layer 235 attempts to find the information in its memory; otherwise it retrieves the information from the database. If users update metadata for assets, the revised information is pushed back to both the database 236 and the metadata caching layer 235.

A data warehouse component 234 of the asset management facility 108 may facilitate online reporting of system assets. For example, online reporting may give administrators instant status information about the facility, key assets, and user activity. This data may be drawn from the database 236, which may be replicated should the original database fail. The database 236 may also be used to support a workflow/publishing component 238 of the asset management facility 108. The workflow publishing component 238 may be used to facilitate organizational distribution of assets, rule-based distribution of assets, ad-hoc exclusive permissions to distribute assets, etc. The workflow/publishing component 238 may also facilitate a user ordering certain assets, controlled by specific administrators and through their approving these requests, access to the media to download can be granted. For example, a user may not have permission to download a given asset, but by adding the asset to their shopping cart and completing (the configurable) questions (e.g., questions related to how the user will use the requested asset), the user submits a request within the system. This request can then be reviewed and accepted or rejected by the administrator. Once the approval occurs, the user is emailed and can then download the asset from the system. In the above example, the questions and workflow also consist of configurable metadata and can be tailored to the clients' needs.

Delivery services 240 of the asset management facility 108 allow for authentication and logging on of end users, streaming services for asset delivery (e.g., in the case of video assets, etc.), compression services (e.g., in the case of large assets), forensic watermarking (e.g., to minimize piracy), metadata injection, etc. The delivery services 240 may be supported by an on-demand platform architecture that supports multiple customers and large storage capacity.

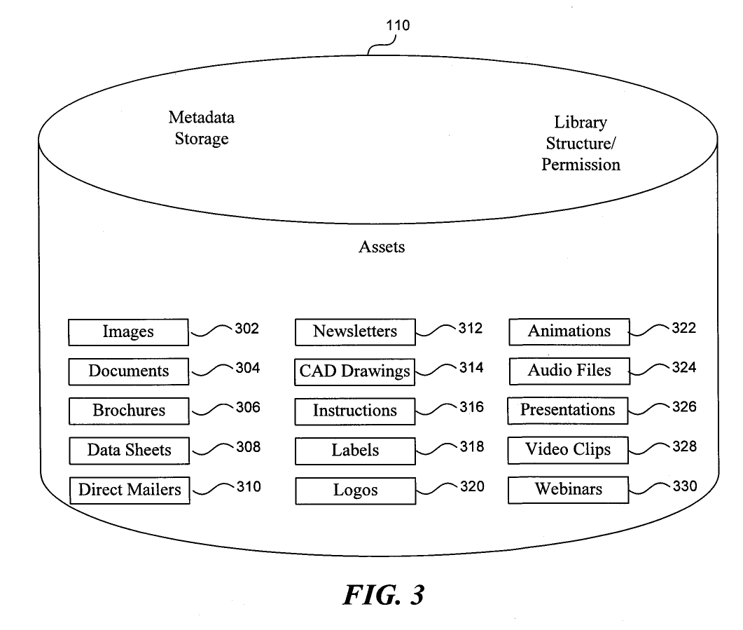

FIG. 3 is a block diagram showing sample contents of an asset repository, such as the asset repository 110 depicted in FIGS. 1 and 2. The asset repository 110 may include almost any type of asset that can be stored electronically (e.g., in digital form). Digital assets may include, but are not limited to, images 302 and documents 304. More specific examples of images 302 and documents 304 include brochures 306, data sheets 308, direct mailers 310, newsletters 312, CAD Drawings 314, instructions 316, product/service labels 318, logos 320, animations 322, audio files 324, presentations 326, video clips 328, webinars 330, etc.

Depending on its contents and configuration, each digital asset may be stored in a format defined by one or more file types. Examples of such file types include .aiff (audio/basic); .asx (Microsoft Stream Redirector file which points to Windows streaming media content files); .au (audio/basic); .avi (Audio Visual Interface); .dcr (Macromedia Director Internet Studio 7 bitmap technology movies); .doc (application MS Word); .exe (Executable program/application); .gif (CompuServe Graphics Interchange Format graphic); .jpg (Joint Photographic Experts Group); .midi (audio/midi Musical Instrument Digital Interface sound file); .mov (Quicktime movie player); .mp3; .mpe (a format proprietary to Destiny Media Technologies); .mpg (Motion Pictures Experts Group); .pdf (Adobe Acrobat); .ppt (MS Powerpoint presentations); .ram (Real Audio pointer file for client application); .rpm (Real Audio pointer file for Real's Internet browser plug-in); .shf (Short lossless); .swf (Macromedia Shockwave Flash Vector technology movies); .torrent (BitTorrent files); .txt (Textpad, Wordpad); .vcs (VideoClipStream from Destiny Media Technologies); .wav (Microsoft sound); .wma (Microsoft Media Audio); .wmv (Microsoft Media Video); .xls (application/vnd.ms-excel MS Excel spreadsheets); files related to video streaming; etc.

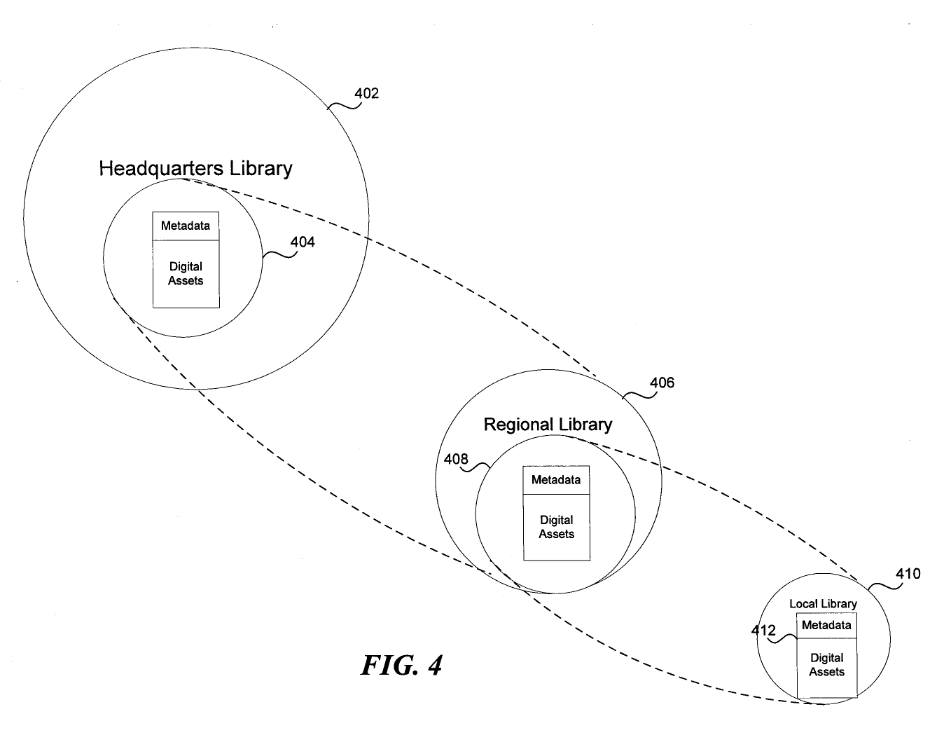

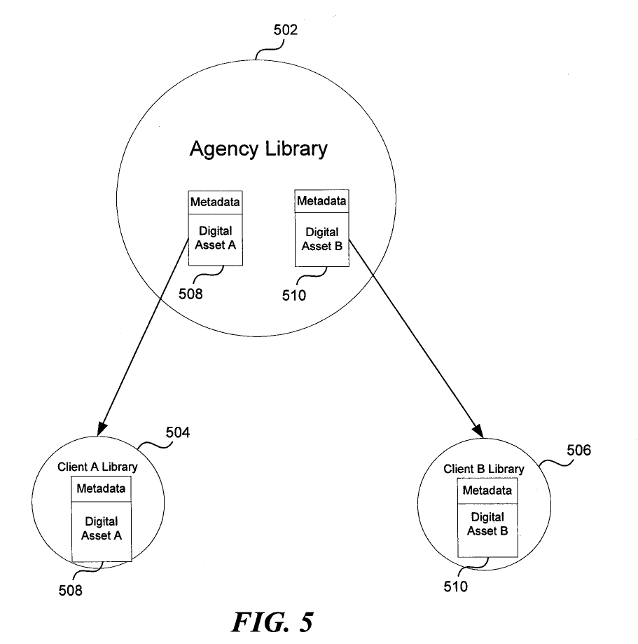

Referring to FIGS. 4 and 5, one aspect of the asset management facility described herein is asset distribution through various virtual libraries. For example, the system may establish virtual libraries as containers for distributing digital assets, which allow users to create new contents for these assets. In some cases, the virtual libraries each correspond to a unique access point or site from which assets can be accessed. FIGS. 4 and 5 show two examples of how such virtual libraries may be configured. In some embodiments, the virtual libraries described below with respect to FIGS. 4 and 5 are configured using virtual assets created and defined using metadata (as opposed to actual copies of the assets themselves). Accordingly, the virtual libraries can be easily created, managed, modified, and customized, without the need for downloading and configuring multiple copies of assets. For example, the virtual libraries may be implemented by providing only one actual version of each asset, with multiple virtual copies available downstream via the virtual libraries. Each virtual copy of an asset may have its own metadata definition with permissions, specific localized language, and so forth. While the virtual copies of assets may each be defined in terms of a unique metadata definition, only a single copy of the media behind the asset may exist (be stored).

In particular, FIG. 4 shows an example of a system where a company “headquarters” 402 defines a library or database 404 having effectively all digital assets owned or controlled by that company. As illustrated, each asset includes at least one metadata definition, which may help in the creation of other downstream libraries, each owning their own subset of assets. For example, administrators at the headquarters 402 can provide permission for a subsidiary, region, or group 406, such as a state or city (e.g., LA office) to own or use a subset 408 of the headquarters' library. That subsidiary or region 406 can then further divide the assets into a smaller group to provide for a local library 412 for yet another subdivision 410 (e.g., an LA market can subdivide its assets into one or more smaller groups). Local users may also upload and manage locally sourced assets.

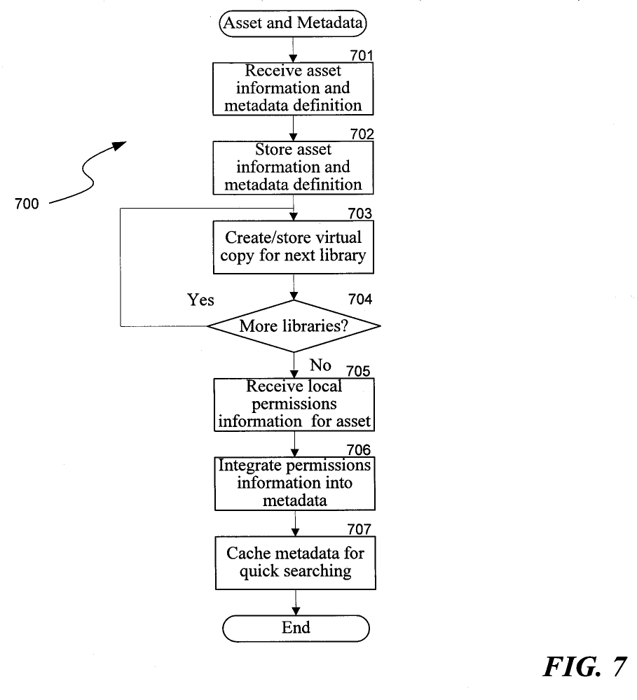

In a second example, shown in FIG. 5, a large library or database 502 contains digital assets (e.g., 508 and 510) intended for use by an agency's (e.g., an advertising agency's) various customers/clients. The agency may have multiple clients/customers, such as Client A and Client B. Because the facility allows multiple virtual libraries, the agency can create a custom virtual library (e.g., 504 and 506) for each of its clients. The agency can then populate each custom virtual library with virtual copies of the appropriate assets for that client (which may include any subset of the assets from the large library 502). An example of such a population process is described with respect to FIG. 7. By appropriately defining separate virtual libraries (e.g., client A library 504 and client B library 506), the agency can subdivide a large inventory of digital assets between its clients (e.g., with or without overlap) simply and securely. The agency can provide an appropriate portion of its digital assets to its clients in a manner that does not involve multiple asset copies and/or multiple environments. For example, through the use of the virtual libraries 504 and 506, asset administrators can avoid having to upload and maintain a separate copy of each asset for each client that requires access.

At a high level, the virtual libraries schemes described with respect to FIGS. 4 and 5 may be implemented by receiving information for an electronically available resource for use in association with the electronic resource management and distribution system; receiving one or more metadata definitions for the electronically available resource (with the one or more metadata definitions including an indication of a group or organization having permission to access the electronically available resource through a corresponding access point); and if the electronically available resource is to be accessed by more than one group or organization, for each of the groups or organizations, populating the corresponding access point with a virtual presence of the electronically available resource (with the virtual presence of the electronically available resource facilitating direct access to the electronically available resource).

In some embodiments, the facility is triggered to generate virtual copies of each asset (e.g., for association with a specified library) when it receives a new metadata definition for that asset and the criteria are matched (e.g., specifying that the artwork is now “final”), thereby populating one or more libraries with digital assets. This process may involve the creation of an initial virtual copy of an asset, from which other virtual copies can be based. Once associated with a virtual library, the virtual asset may then be under the control of the administrator for the virtual library, but may still be linked back to the metadata for the original digital asset (e.g., residing in the asset repository 110 of FIG. 1). In this way, any asset may be used locally and modified/shared as needed, while still retaining central association.

At the local or virtual library level, the facility may allow administrators to set up different types of users (defined by a metadata profile) with different rights/permissions. Once initial setup is performed, the facility may also allow administrators to modify this information (e.g., to change the context of different user attributes/metadata and rights associated with one or more digital assets). In this way, the facility provides a fine-grained permissions model. In some embodiments, the facility integrates the metadata with the permissions into a single document or file. This allows users of the facility to define even complex permissions and permits access for manipulation of a large number of assets without slowing the system.

Central system administrative users that are in charge of controlling how virtual libraries are structured and which assets they contain may, to some extent, retain control over local-level asset instances. For example, such users may be able to change/upload new media formats, delete specific downstream asset instances (or entire groups of downstream asset instances), and/or modify metadata exclusively with respect to a particular downstream asset instance (or to an entire group of downstream asset instances). In many cases, the modifications may be automatic/mandatory or, alternatively, may be presented as a request to local administrative users (e.g., “It is recommended that you modify/delete this asset, which is associated with your library”). When automatic/mandatory changes to asset metadata are made centrally (e.g., at the headquarters level), the facility may provide notification to each library having a virtual copy of the asset. In addition, the facility may allow for side-by-side comparison of multiple versions of assets so that changes made at the central level can be highlighted at the local level(s) (and vice versa) in case corrections or further modifications are desired. In a related context, the facility may provide an interface that allows local administrators to determine whether there is a discrepancy with a local instance of an asset after an upstream instance of the same asset has changed. For example, by clicking a link, the administrator may be able to compare the two versions and select to apply those changes from the upstream owner to the local instance, etc.

In some cases, users of the local virtual libraries, depending on their permissions, may have some ability to modify specified aspects of the asset or its metadata. For example, such users may be able to modify asset metadata, organize assets into sets or projects, change previews and details of assets, update relationships between assets and media files, modify or add permissions for users at a local level, delete the local instance of the asset, etc.

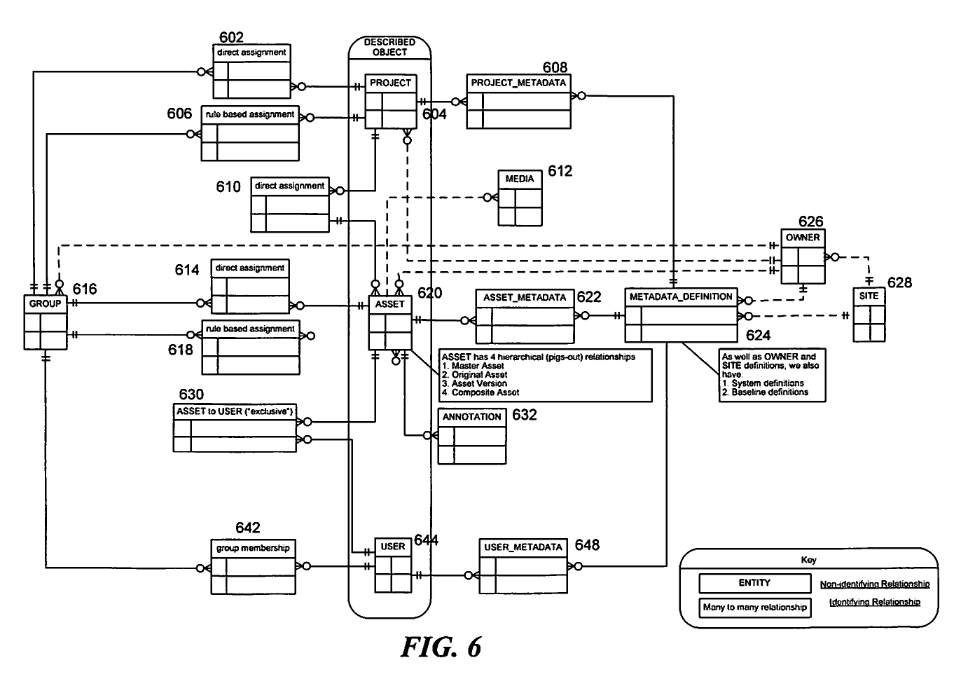

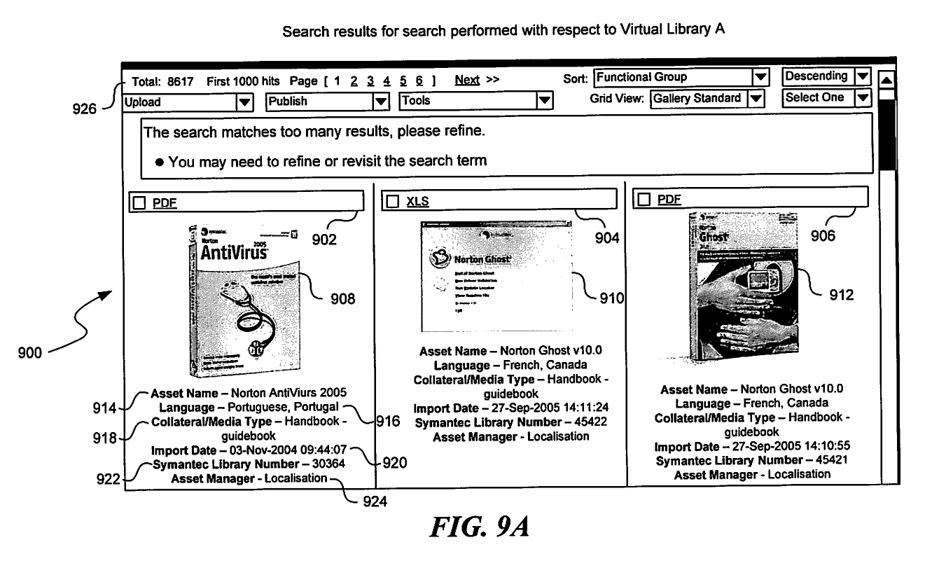

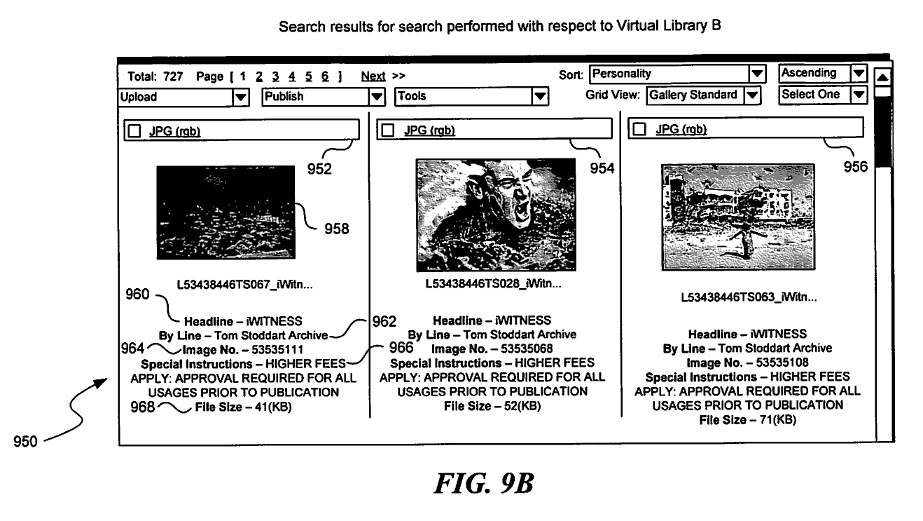

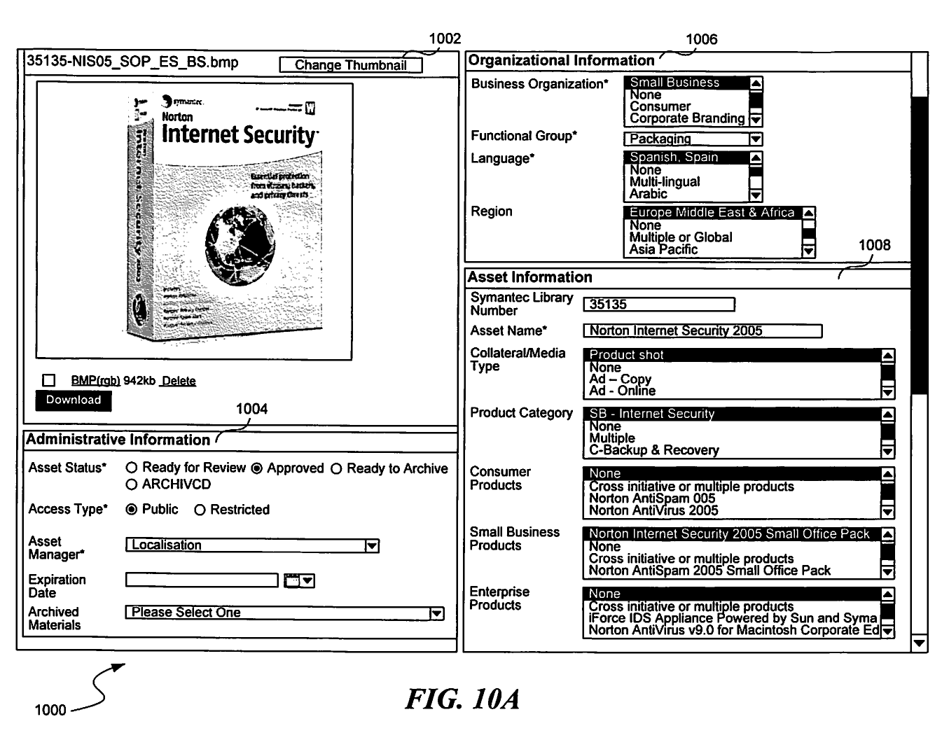

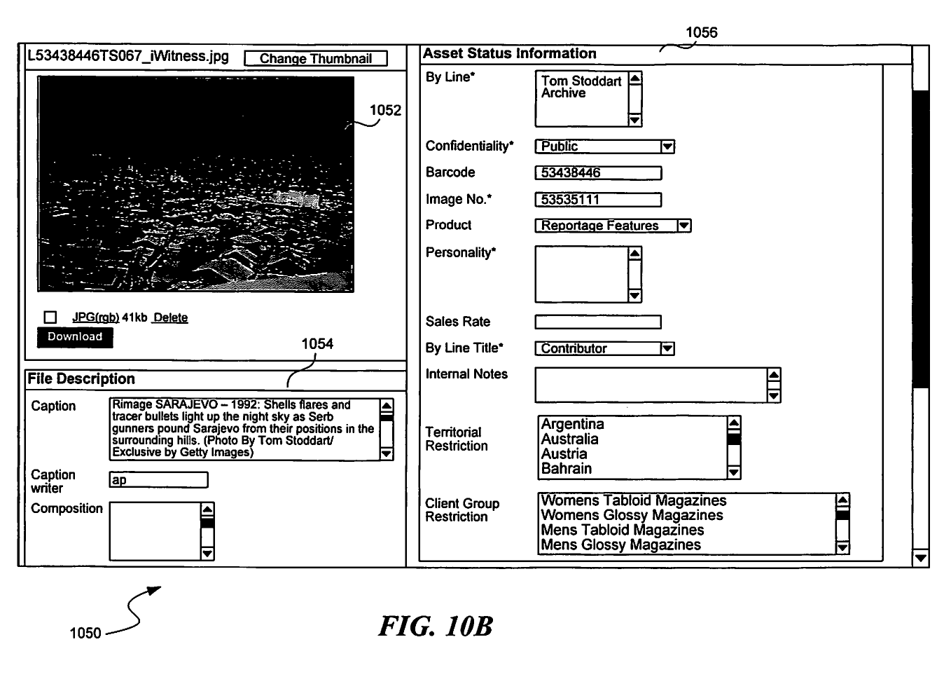

An example of entity relationships associated with a metadata model for the asset management facility is illustrated with respect to FIG. 6. This metadata model may have several aspects and features. At a high level, the metadata model allows for the creation of virtual assets and of permissioning schemes, facilitates searching, and provides other functionality. In some embodiments, the facility's entity relationships may be among several entities, which may be implemented, for example, as objects in an object-oriented programming scheme. The entities may include one or more described objects (e.g., described by users) including project objects 604 (e.g., created each time a new project is started), asset objects 620 (e.g., instantiated when a new asset is ingested into the facility), and user objects 644 (e.g., instantiated when a new user is registered/accepted into the system). Each described object/entity has its own metadata entity. For example, project objects 604 have project metadata 608, asset objects 620 have asset metadata 622, and user objects 644 have user metadata 648. As described with respect to FIGS. 9A-10B, this metadata may describe and define the asset, and may be varied independently for each instance of the asset associated with the facility (e.g., globally or at an individual virtual library/site level). In addition, assets may be associated with underlying media entities 612 and annotation entities 632 (e.g., including notes or other special instructions associated with an asset).

For each project 604, asset 620, or user 644 instance, the underlying structure and/or composition of the corresponding metadata entity may be controlled by a metadata definition 624, which may exist independently for each particular owner library 626 and/or site 628 that is associated with a given asset. Separate metadata definition entities may exist for various systems (not shown) and/or baselines (not shown). In this way, for example, each asset (e.g., which can be a master asset, an original asset, an asset version, an initial virtual asset, a secondary virtual asset, a composite asset, etc.) can have multiple metadata definitions associated with it, each based on the owner(s) of the asset and/or the site/virtual library through which the asset is accessed. Accordingly, the metadata definition 624 allows for the creation of virtual copies of assets and the configuration of multiple virtual libraries.

One feature of the metadata model is that it allows permissioning schemes to be implemented. At a high level, such permissioning schemes allow for receiving a search request for assets from a user (with the user having access to a set of assets via a specified asset retrieval site that corresponds to a virtual library of assets comprising virtual assets and with each asset in the virtual library of assets being associated with metadata unique to the assets as they reside in the virtual library); determining an indication of an identity of the user based, at least in part, on information in the received search request; identifying at least one search term based on the information in the received search request; examining the metadata unique to the assets as they reside in the virtual library to determine a set of assets that satisfy the received search request and that the user has permission to access; and presenting an indication of the set of assets to the user.

To implement a permissions framework on a granular level (e.g., to distinguish which users associated with a particular site or virtual library can have access to assets and/or projects), several assignment entities may be implemented to bear a relationship with project objects 604, asset objects 620, and user objects 644. These assignment entities may comprise a direct assignment 602 of a project 604 to a group, a rule-based assignment 606 of a project 604 to a group 616, a direct assignment 610 of an asset 620 to a project 604, a rule-based assignment 618 of an asset 620 to a project 604, a group membership association 642 of a user 644 to a group 616, etc. In addition, an asset can obtain an exclusive assignment 630 to a user. For example, as illustrated in the XML information below (which provides an example of an asset data structure implemented using XML), groups 107 and 109 (both examples of group entities 616) may comprise the groups of users with permission to access the asset and group 113 might be a group of users with administrative rights on this asset.

<?xml version=“1.0” encoding=“UTF-8”?>
<zones>

<described_object_type>1</described_object_type>
<described_object>100897</described_object>
<owner>10240</owner>
<created>d08112004 w452004 m112004 y2004</created>

<picklists>

<def_1033>7008</def_1033>
<def_1037>7015</def_1037>
<def_1037>7016</def_1037>
<def_1039>480</def_1039>

</picklists>
<dates>

<def_1041>d22092004 w382004 m092004 y2004</def_1041>

</dates>
<numbers>

<def_1047>30000</def_1047>

</numbers>
<strings>

<def_1042>The 2006 Escalade is a boldly assertive SUV that

evokes a true sense of driver confidence. It's chiseled exterior with
crisp lines and a muscular stance project a sense of power. And rightfully
so. Feel the road to feed your need and take the road without excuses.
</def_1042>
</strings>

<groups>

<group>107</group>
<group>109</group>
<group>113</group>

</groups>

</zones>

In some embodiments, the facility's metadata model (and associated data structures) combines metadata with asset permissions elements in a simple XML data character large object (CLOB). These CLOBs may be indexed together so all searches and all navigation within the system can be combined to give a fast, scaleable solution. For example, the facility may employ XML CLOBs with Sections to store consolidated metadata in the database for each asset. This may facilitate searching of metadata for particular information easily and effectively without the need to join various relational tables. By expressing the metadata structure in XML, the facility may, for example, encompass many client models on a single platform. In addition, the XML may facilitate in implementing the facility across platforms.

High levels of performance may be achieved by using these XML CLOBs within an index which resides in the database servers. Combining this with the metadata cache (where all metadata information can be cached in memory) optimizes the process of retrieving results from searches.

The facility may also constantly or periodically update the metadata associated with its assets. For example, various off-the-shelf APIs may be used for updating and manipulating, which permit conducting such activities as background processes. For example, assets and their associated metadata can be ingested in several ways, from embedded IPTC captioning, XML data files, or spreadsheets. Further, in conjunction with XML CLOBs, the facility may use an off-the-shelf text index (e.g., Oracle's Text Index, which is explained in more detail at http://www.oracle.com/technology/products/text/index.html) to provide a flexible search solution. Some of these text indices may have the ability to index keywords in different languages, which facilitates searching by many criteria and techniques such as free text, date, and Boolean searching.

In addition to using XML CLOBS and text indices for more efficient searching, the facility may employ a web cache of the most frequently executed metadata search queries, thereby reducing database traffic. In some embodiments, a cache manager stores a list of asset IDs stored against a specific search query, thereby conserving facility resources. To further facilitate this searchability, information conducive to a WHERE clause (e.g., asset permissions and other structured data) may be embedded into the metadata index.

FIG. 7 is a flow diagram showing an example of a routine 700 for generating asset metadata definitions in an embodiment. For example, the routine 700 may be used in association with a method that allows for assembling information relating to multiple electronic assets; the generating of a first virtual electronic representation of an asset from the multiple electronic assets; the populating of a first virtual electronic library with the first virtual electronic representation of the asset (with the first virtual electronic library comprising a first access point for the asset having access to the asset defined, at least in part, using a first set of asset metadata); and the populating of a second virtual (or third, or fourth, etc.) electronic library with a second virtual representation of the asset based on the first virtual electronic representation of the asset (with the second virtual electronic library comprising a second access point for the asset having access to the asset defined, at least in part, using a second set of asset metadata that differs from the first set of asset metadata).

In some embodiments, the asset metadata definitions allow for the creation of virtual libraries and/or the population of assets available to a particular site. At block 701, as part of an asset publication process, the routine 700 receives asset information, which may include various types of metadata definitions (including or based on asset owner and/or site information) as well as the raw information related to the asset itself. At block 702, the routine 700 stores the received asset information and metadata definitions in an information repository, such as the asset repository 110 of FIG. 1. Part of this process may correspond to the ingestion of assets into the system. At block 703, the routine 700 creates one or more virtual copies of the asset for population in a virtual library based on the provided metadata definitions and based on new metadata definitions. In some embodiments, this may include creating an initial virtual asset, from which subsequent virtual assets can be based. At decision block 704, if there are additional libraries to be populated with an instance of the asset, the routine 700 loops back to block 703 to create a virtual copy for the next virtual library. Otherwise, the routine 700 continues at block 705 to receive fine-grained permissions information and/or other asset metadata at the local/virtual library level. Each time a virtual copy of an asset is created, the routine 700 may retain a virtual link back to the master asset. In this way, system administrators for virtual libraries can revert back to the master asset metadata if desired. At block 706, the local permissions information is integrated into the asset metadata for the local version of the virtual copy. At block 707, the routine 700 caches the asset metadata for quick searching at the virtual library level, and then ends.

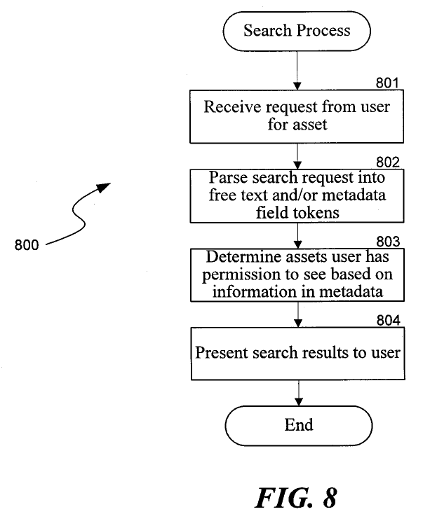

FIG. 8 is a flow diagram showing an example of a routine 800 for searching for assets, wherein the searching is performed, at least in part, based on asset metadata. At a high level, the searching may include receiving a search request for assets from a user having access to a set of assets via a specified asset retrieval site that corresponds to a virtual library of assets associated with multiple assets; parsing the search request into one or more tokens; identifying one or more assets from the virtual library of assets based on matching the one or more tokens with tagging information unique to the assets as they reside in the virtual library; and displaying an indication of the identified one or more assets to the user.

At block 801, the routine 800 receives a search request from a user requesting that assets meeting specified search criteria be retrieved. The request may be generated using a query builder. At block 802, the routine 800 parses the search request into tokens including free text tokens (for searching assets based on textual descriptions associated with the assets) and metadata field tokens (for searching assets based on metadata). In some embodiments, the metadata field tokens may include information identifying the user, which allows the routine 800 to limit the search results to only those assets that the user has been given permission to view. Accordingly, at block 803, the routine 800 determines assets that the user can access based on permissions information associated with the asset metadata. At block 804, the routine 800 presents the results of the searching. The search results include the assets that the user has permission to view that also meet the search criteria.

The search routine 800 described above may be further illustrated via the use of a car dealership example. In this example, assets comprising pictures and descriptive information about new car models may be distributed from the car manufacturer to multiple different dealerships via individual dealership sites, each associated with a virtual library of assets, containing a subset of the entire set of assets owned by the car manufacturer. The manager of a car dealership may then use fine-grained permissions model to control which assets in the virtual library each employee at the dealership can access. For example, the manager may have access to information about every asset in the virtual library while individual sales representatives may have access only to select assets (e.g., permissions limit users' ability to search and access to only those assets pertaining to car models that the individual is authorized to sell).

FIGS. 9A, 9B, 10A, and 10B are display diagrams illustrating aspects of assets and associated metadata in an embodiment of the management facility. These display diagrams may include various user screens, views, and other interfaces that allow users to search for, access, view, and modify assets and/or asset metadata. While only certain examples are given, a person skilled in the art will appreciate that many other interfaces could be implemented without departing from the scope of the invention. The terms “screen,” “window,” and “page” are generally used interchangeably herein. The pages described herein may be implemented using, for example, WML (wireless markup language), HTML (hypertext markup language). XHTML (extensible hypertext markup language), XML (extensible markup language), or XSLT.

The screens or web pages provide facilities to receive input data, such as a form with fields to be filled in, pull-down menus or entries allowing one or more of several options to be selected, buttons, sliders, hypertext links, or other known user interface tools for receiving user input. While certain ways of displaying information to users are shown and described with respect to certain Figures, those skilled in the relevant art will recognize that various other alternatives may be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other) where the layout and information or content to be displayed on the page is stored in memory, a database, or other storage facility.

When implemented as web pages or wireless content, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database and dynamically generated in response to user requests. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats.

In general, for ease in describing features of the invention, aspects of the invention will now be described in terms of a user interacting with the asset management facility via his or her user computer or mobile device. As implemented, however, the user computer receives data input by the user and transmits such input data to aspects of the asset management facility. The asset management facility then queries one or more databases, retrieves requested pages, performs computations, and/or provides output data back to the user computer, typically for visual display to the user.

Referring to FIG. 9A, a screen 900 shows partial results of a search query (e.g., executed by a user with access to assets via a virtual library of assets). As is illustrated by the large number of search results (8,617), the facility may be configured to handle a large number of assets (although as in this case, search results may be limited to a smaller number of assets—in this case 1000). The search query results are displayed to the user broken down by asset (902, 904, 906), with each asset having a descriptive graphic or thumbnail (908, 910, 912) associated with it. The set of metadata (here items 914, 916, 918, 920, 922, and 924) that is viewable for each of the three displayed assets is based on parameters that are specific to the virtual library through which the assets are accessed (Virtual Library A). In other words, while some of these same assets may be accessed through a different virtual library, the viewable metadata for each asset may differ based on the viewable metadata parameters for the different virtual library. In addition, such viewable metadata parameters may be subsequently modified and/or further refined as appropriate, so that the model(s) employed by the virtual library may be maintained.

Aspects of metadata for each asset are described under the respective thumbnail (908, 910, 912). For example, the Norton AntiVirus product shot asset 902 (comprising a “product shot” of a software product that can be used, for example, for product marketing) displays asset name metadata 914 (Norton AntiVirus 2005), asset language metadata 916 (Portuguese, Portugal), asset collateral/media type 918, import date metadata 920, library number metadata 922 (e.g., the number assigned to the asset within the given library or virtual library these numbers can be used as a unique index of assets within a library), and asset manager metadata 924 (e.g., localization—configured to be the owning group of the asset, determined as the asset is uploaded). As illustrated in the upper tool bar 926 of screen 900, various display/sorting options may be available (e.g., sort by function group in descending order, etc.).

FIG. 9B shows an example of asset search results and asset metadata in a screen 950 for a different virtual library (Virtual Library B). In the illustrated example, the displayed assets (952, 954, 956) comprise 3 of 727 search results. In this case, the displayed assets (952, 954, 956) are reportage features (e.g., images for use in news stories). The metadata associated with the respective assets is also illustrated, and as can be seen from the two diagrams—different appropriate metadata fields have been configured for this particular virtual library (as compared with the virtual library shown in FIG. 9A). For example, the visible metadata associated with the asset 952 includes a thumbnail image 958, a headline 960 (iWITNESS), a by line 962 (Tom Stoddart Archive), an image number 964, special instructions 966 (“HIGHER FEES APPLY: APPROVAL REQUIRED FOR ALL USAGES PRIOR TO PUBLICATION”), and file size 968.

FIG. 10A shows a screen 1000 associated with modifying metadata associated with the Norton AntiVirus product shot asset 902 of FIG. 9A. Some of the metadata features are marked with an asterisk, indicating that they will be available for viewing by users when the facility returns the corresponding asset as a search result, as illustrated in FIG. 9A. It may be possible for a system administrator of a virtual library (or even a headquarters library) to modify asset metadata in any number of ways. For example, the system administrator may be able to change the thumbnail associated with an asset by selecting a CHANGE THUMBNAIL option 1002. The system administrator may also have options to modify administrative information associated with an asset (e.g., asset status, access type, asset manager, expiration date, archived materials, etc.) by selecting one or more options in an ADMINISTRATIVE INFORMATION portion 1004 of the screen 1000. Likewise, via an ORGANIZATIONAL INFORMATION portion 1006 of the screen 1000, the system administrator may modify metadata relating to availability of the asset within the organization (e.g., business organization, functional group, language, region, etc.).

An ASSET INFORMATION portion 1008 of the screen 1000 allows the system administrator to modify information specific to the asset itself (e.g., library number, asset name, collateral/media type, product category, consumer products, small business products, enterprise products, etc.). As illustrated, the asset metadata structure may be specific to the type of asset (in this case, an image of a product). Accordingly, in some embodiments, it may be possible to modify the structure of asset metadata (e.g., the fields provided in relation to asset information), as well as setting/changing the value of existing metadata fields.

FIG. 10B shows a screen 1050 associated with modifying metadata associated with the reportage feature asset 952 of FIG. 9B. In addition to a thumbnail section 1052, the metadata aspects that the user may modify are displayed in a FILE DESCRIPTION portion 1054 of the screen 1050 and an ASSET STATUS INFORMATION portion 1056 of the screen 1050. The metadata that the user may modify in the FILE DESCRIPTION portion 1054 include a caption (e.g., which may include search terms used in a natural language search), a caption writer, composition information, etc. The metadata that the user may modify in the ASSET STATUS INFORMATION portion 1056 include a by line, confidentiality information, barcode information, image number information, product information, personality information, sales rate information, by line title information, internal notes, territorial restrictions, client group restrictions, etc. The metadata fields with an asterisk may be those that are displayed (where applicable) in search results, as depicted in FIG. 10A. The metadata structures illustrated in FIGS. 10A and 10B differ based on the fact that they relate to different virtual libraries. In addition, different asset types themselves may call for metadata structures that vary accordingly. In some embodiments, the metadata structure may be altered by library administrators, as well as the values for individual assets. This feature may be implemented without the changing program code via flexible XML data structures or the like.

### CONCLUSION

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications, and other references, including any that may be listed in accompanying filing papers, are incorporated herein by reference, including U.S. Pat. No. 6,735,583. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

I/We claim:

1. In a system for the management and distribution of assets accessible to multiple users, a method comprising:
assembling information relating to multiple electronic assets comprising images, audio, or video, wherein the information includes a computer-readable form of each of the multiple electronic assets;
generating a first virtual electronic representation of an asset from the multiple electronic assets, wherein the first virtual electronic representation of the asset has a first set of asset metadata and wherein the first set of asset metadata includes first permissions data;
automatically populating a first virtual electronic library with the first virtual electronic representation of the asset without requiring the multiple users to perform a drag and drop operation, wherein the first virtual electronic library comprises a first access point for the asset, and wherein access to the asset via the first virtual electronic library is defined, at least in part, using the first set of asset metadata;
organizing the first virtual library according to the needs of a first organization or suborganization;
generating a second virtual representation of the asset, wherein the second virtual electronic representation of the asset has a second set of asset metadata, and wherein the second set of asset metadata includes second permissions data;
automatically populating a second virtual electronic library with a second virtual representation of the asset based on provided metadata definitions without requiring a user to perform a drag and drop operation, wherein the second virtual electronic library comprises a second access point for the asset and wherein access to the asset via the second virtual electronic library is defined, at least in part, using the second set of asset metadata, and; and
organizing the second virtual library according to the needs of a second organization or suborganization;
wherein the first organization includes multiple users, and wherein the second organization also includes multiple users;
wherein the first organization and the second organization comprise separate companies, customers or clients, wherein the second virtual electronic representation of the asset is based on the images, audio, or video, wherein the first set of asset metadata and the second set of asset metadata do not include common metadata.

2. The method of claim 1, further comprising:
linking the first virtual electronic library with the second virtual electronic library based on configurable, metadata driven rules.

3. The method of claim 1, further comprising:
modifying the first virtual electronic library according to changing needs of an organization associated with the first virtual electronic library, wherein the restructuring includes updating the first set of metadata.

4. The method of claim 1 wherein the first virtual electronic library and the second virtual electronic library are implemented in a single database.

5. The method of claim 1 wherein the multiple users comprise users associated with the first virtual electronic library and users associated with the second virtual electronic library and the second permissions data defines whether users associated with the second virtual electronic library have access to the first virtual representation of the asset, and wherein at least some of the second permissions data is used in accessing the first virtual representation of the asset from the first virtual electronic library as the result of performing a search query, wherein the search query is performed by a method comprising:
receiving a search request from a user;
determining an indication of an identity of the user based on information in the received search request;
determining at least one search term based on the information in the received search request;
examining at least a portion of the asset metadata associated with the first virtual electronic library to identify a set of assets that are accessible from the first virtual electronic library, that each satisfy the received search request, and that the user has permission to access based on the indication of identity; and
presenting an indication of the set of assets to the user.

6. A system for the management and distribution of assets, comprising:
a virtual asset receiving engine configured to populate one or more user access points with virtual electronic representations of electronic assets;
a database component for storing at least one of:
information relating to multiple electronic assets comprising images, audio, or video, wherein the information includes a computer-readable form of each of the multiple electronic assets;
information defining initial virtual electronic representations of at least some of the multiple electronic assets, wherein each of the initial virtual electronic representations is accessible via a user access point that is defined, at least in part, using asset metadata specific to the user access point; and
information defining subsequent virtual electronic representations of at least some of the multiple electronic assets, wherein each of the subsequent virtual electronic representations is based, at least in part, on a corresponding initial virtual electronic representation and is accessible via a user access point that is distinct from the access point for the corresponding initial virtual electronic representation;
an initial virtual library comprising the initial virtual electronic representations organized according to the needs of a first organization; and
a subsequent virtual electronic library comprising the subsequent virtual electronic representations organized according to the needs of a second organization;
wherein the first organization includes multiple users, and wherein the second organization also includes multiple users;
wherein the first organization and the second organization comprise logical working areas for subdivisions of a company or headquarters;
wherein the initial virtual library and the subsequent virtual electronic library are automatically populated without requiring a drag and drop operation; and
wherein the information defining initial virtual electronic representations is not equal to the information defining subsequent virtual electronic representations.

7. The system of claim 6 wherein, for at least some of the multiple electronic assets, the information defining the subsequent virtual electronic representation is the same as the information defining the corresponding initial virtual electronic representation, except for a reference to the user access point that is distinct from the access point for the corresponding initial virtual electronic representation.

8. The system of claim 6 wherein a user having permission unique to an access point is able to retrieve one or more assets from that access point based, at least in part, on the information defining the initial virtual electronic representations or the information defining the subsequent virtual electronic representations.

9. The system of claim 6 wherein a user having permission unique to the user access point that is defined, at least in part, using the asset metadata specific to the user access point is able to access one or more assets from that access point based, at least in part, on the information defining the initial virtual electronic representations, and based, at least in part, on search criteria provided by the user, wherein the search criteria is provided to perform a search by a method comprising:
receiving a search request containing the search criteria;
parsing the received search request into one or more tokens;
identifying at least one electronic asset from the access point based on matching the one or more tokens with the asset metadata and based on checking user group membership information and asset-related permissions; and
displaying results of the search.

10. The system of claim 9 further comprising allowing the asset metadata to be cached to increases performance of the system.

11. The system of claim 9 wherein identifying at least one electronic asset from the access point is further based on matching the one or more tokens with tagging information.

12. The system of claim 11 wherein the tagging information includes tagging information associated with at least one foreign language translation associated with using one or more assets.

13. In a system for the management and distribution of assets accessible to multiple users, a method comprising:
assembling information relating to multiple electronic assets comprising images, audio, or video, wherein the information includes a computer-readable form of each of the multiple electronic assets;
generating a first virtual electronic representation of an asset from the multiple electronic assets, wherein the first virtual electronic representation of the asset has a first set of asset metadata and wherein the first set of asset metadata includes first permissions data;
automatically populating a first virtual electronic library with the first virtual electronic representation of the asset without requiring the multiple users to perform a drag and drop operation, wherein the first virtual electronic library comprises a first access point for the asset, and wherein access to the asset via the first virtual electronic library is defined, at least in part, using the first set of asset metadata;
organizing the first virtual library according to the needs of a first organization or suborganization;
generating a second virtual representation of the asset, wherein the second virtual electronic representation of the asset has a second set of asset metadata, and wherein the second set of asset metadata includes second permissions data;
automatically populating a second virtual electronic library with a second virtual representation of the asset based on provided metadata definitions without requiring a user to perform a drag and drop operation, wherein the second virtual electronic library comprises a second access point for the asset and wherein access to the asset via the second virtual electronic library is defined, at least in part, using the second set of asset metadata, and; and
organizing the second virtual library according to the needs of a second organization or suborganization;
wherein the first organization includes multiple users, and wherein the second organization also includes multiple users;
wherein the first organization and the second organization comprise logical working areas for subdivisions of a company or headquarters, wherein the second virtual electronic representation of the asset is based on the first virtual electronic representation of the asset, wherein the first set of asset metadata and the second set of asset metadata include at least some common metadata, and wherein the first set of asset metadata is not equal to the second set of asset metadata.

14. The method of claim 13, further comprising:
linking the first virtual electronic library with the second virtual electronic library based on configurable, metadata driven rules.

15. The method of claim 13, further comprising:
modifying the first virtual electronic library according to changing needs of an organization associated with the first virtual electronic library, wherein the restructuring includes updating the first set of metadata.

16. The method of claim 13 wherein the first virtual electronic library and the second virtual electronic library are implemented in a single database.

17. The method of claim 13 wherein the multiple users comprise users associated with the first virtual electronic library and users associated with the second virtual electronic library and the second permissions data defines whether users associated with the second virtual electronic library have access to the first virtual representation of the asset, and wherein at least some of the second permissions data is used in accessing the first virtual representation of the asset from the first virtual electronic library as the result of performing a search query, wherein the search query is performed by a method comprising:
receiving a search request from a user;
determining an indication of an identity of the user based on information in the received search request;
determining at least one search term based on the information in the received search request;
examining at least a portion of the asset metadata associated with the first virtual electronic library to identify a set of assets that are accessible from the first virtual electronic library, that each satisfy the received search request, and that the user has permission to access based on the indication of identity; and
presenting an indication of the set of assets to the user.
